(19) United States
(12) Patent Application Publication
(10) Pub. No.: US 2016/0308688 A1
(43) Pub. Date: Oct. 20, 2016

(54) Communication Module for a Field Bus Device

(71) Applicant: ROBERT BOSCH GMBH, Stuttgart (DE)

(72) Inventors: Till Deubel, Neunkirchen (DE); Marco Witzmann, Würzburg (DE)

(21) Appl. No.: 15/022,498

(22) PCT Filed: Sep. 11, 2014
(86) PCT No.: PCT/EP2014/069337

§ 371 Date: Jun. 27, 2016

(30) Foreign Application Priority Data
Sep. 17, 2013 (DE) 102013218566.9

(51) Int. Cl. H04L 12/40; H04L 29/08

(52) U.S. Cl. CPC H04L 12/40032; H04L 67/02

(57) ABSTRACT

A communication module for at least one field bus device includes a field bus interface, a data processing device, and a communication interface. The field bus interface is configured to question and/or to modify at least one parameter from the at least one field bus device which is connected and/or can be connected via a field bus to the field bus interface. The data processing device is configured to provide a user interface for the at least one parameter. The communication interface is configured to provide the user interface for the human-machine-interface.

The present invention relates to a communication module for at least one fieldbus device and/or to a hydraulic controller comprising a corresponding communication module, and to a method for communicating with a fieldbus device.

Field devices that are connected to a fieldbus, for instance devices such as bus valves, electrical drives, sensors or programmable logic controllers (PLCs), capture a large amount of data. The captured data can include, amongst other data, temperature, spool position or oscilloscope recordings. At present, this data can only be read using special software from a laptop or computer connected to the fieldbus. Thus the data is not captured continuously, nor is it available to users without specific software or to people who are not on site.

The object of the present invention is to provide an improved communication module for at least one fieldbus device, an improved hydraulic and/or electrical controller comprising a corresponding communication module, and an improved method for communicating with a fieldbus device.

This object is achieved by a communication module for at least one fieldbus device, by a hydraulic controller comprising a corresponding communication module and by a method for communicating with a fieldbus device as claimed in the main claims. The subclaims and the following description contain advantageous embodiments.

The present invention is based on the knowledge that a user interface for a multiplicity of different terminals can be provided via a communication interface. In a communication module, at least one parameter of a field device can be read via the fieldbus and provided in a user interface, and/or a parameter can be modified in the field device via the user interface. Thus at least one parameter of at least one field device can be provided to a user locally and/or globally.

Data from at least one field device connected to a fieldbus and relating to a current and/or long-term condition can advantageously be provided.

A communication module for at least one fieldbus device has the following features:

at least one fieldbus interface, which is designed to retrieve at least one parameter from the at least one fieldbus device that can be connected and/or is connected via a fieldbus to the fieldbus interface, and/or to modify said at least one parameter;
a data processing unit, which is designed to provide a user interface for the at least one parameter; and a communication interface, which is designed to provide the user interface for a Human Machine Interface.

A communication module can be understood to mean here an electrical device which receives and/or monitors and/or outputs signals and/or at least one parameter via a fieldbus. The communication module may also be understood to be a monitoring tool, which can be used to read and write parameters. In one embodiment, the communication module can be capable of operating in real-time. The at least one parameter may be at least one sensor signal. The at least one parameter may be at least one signal for controlling an actuator or final control element. The at least one parameter may represent a system state, a physical signal or a process variable of a field device. The field device may in this case be in the form of a final control element, a bus valve, an electrical drive or a sensor.

The communication module can be designed to process the at least one parameter, and on the basis thereof provide and/or output a user interface for the at least one parameter and/or control signals and/or data signals. The communication module can comprise a plurality of fieldbus interfaces. The fieldbus interface and the communication interface can be in the form of hardware and/or software. When in hardware form, the interfaces may be part of what is known as a system ASIC, which contains a very large range of functions of the communication module. It is also possible, however, that the interfaces are dedicated integrated circuits or are composed, at least in part, of discrete components. When in software form, the interfaces may be software modules, which exist, for instance, in addition to other software modules on a microcontroller. The data processing unit can be implemented as an integrated circuit. A fieldbus interface can be understood to be an interpreter.

In one embodiment, a plurality of field devices can be connected to the fieldbus. A plurality of parameters can be read and/or modified for one field device.

The communication module can advantageously be used to provide simpler commissioning, for example by means of quick plausibility tests checking the correct connections of hydraulic lines, to provide condition monitoring, for instance by recording temperature curves and identifying trends therein, and to provide easier and faster troubleshooting, for instance by reading the parameters directly without additional software. The communication module can facilitate telemaintenance and support from off-site service staff.

It is also advantageous if the communication module comprises a substantially cuboid housing having a connection for the fieldbus interface and a connection for the communication interface and comprises an integrated circuit. In this case, the data processing unit can be part of the integrated circuit. The fieldbus interface can be connected to the communication interface via the integrated circuit. The housing can have a length of 20 cm maximum, for example a length of 18 cm, a width of 15 cm maximum, for example a width of 12 cm, and a height of 7 cm maximum, for example a height of 5 cm. The housing can have a degree of protection for operating under harsh environmental conditions. The fieldbus interface and/or the communication interface can comply mechanically and/or electrically with a standardized interface or an interface standard. In this case, the housing can comprise a recess for the fieldbus interface and/or the communication interface.

In addition, the communication module can comprise a storage device, which is designed to store the at least one parameter and, simultaneously or alternatively, a plurality of the at least one parameter. A storage device can be understood to be a data memory. The storage device can comprise a database. The storage device can be designed to store a variation over time of the at least one parameter. In this case, a plurality of the parameter can be stored in a database. A storage device can advantageously provide a variation over time and/or facilitate identification of a trend.

Moreover, the user interface can be designed as a Web interface. The data processing unit can comprise a Web server. The Web interface can be designed to display the at least one parameter and/or to receive from a user the at least one parameter in the form of a modified value of the parameter.

The data processing unit can be designed to use the at least one parameter to control at least one function of the at least one fieldbus device. If the fieldbus device is an actuator, a sensor or a programmable logic controller (PLC), the data processing unit can provide at least one modified parameter via the fieldbus interface and hence control the field device or, more precisely, control a function of the field device. In this case, the at least one parameter can be modified via the user interface in order to control the at least one field device. For instance, a resolution or a sampling rate may be adjustable for a sensor.

In addition, the data processing unit can be designed to detect the fieldbus device that can be connected and is simultaneously or alternatively connected via the fieldbus interface and/or via the fieldbus, and/or to provide information about the at least one parameter and/or the at least one function for a plurality of fieldbus devices that can be connected via the fieldbus interface and/or via the fieldbus. The data processing unit can comprise a detection device for fieldbus devices. In this case, the data processing unit can comprise information containing function data and, simultaneously or alternatively, containing communications data from potentially connected or connectable fieldbus devices. In this case, the information containing function data and, simultaneously or alternatively, containing communications data exists in the form of a database.

Furthermore, the fieldbus interface can be embodied as a Profinet interface and/or a Sercos interface and/or a CAN interface and/or a CANopen interface and/or a Profibus interface and/or a Foundation Fieldbus interface and/or an EtherCAT interface and/or an INTERBUS interface and/or a VARAN bus interface. The fieldbus interface can be designed as a standardized fieldbus interface. In this case, the standardized fieldbus interface can comprise a physical (i.e. mechanical) and/or electrical layer and, simultaneously or alternatively, a protocol layer.

In one embodiment, the Human Machine Interface can be in the form of a computer and/or a portable computer and/or a smartphone and/or a tablet. The Human Machine Interface can comprise a visualization device and an input device. Said visualization device and said input device can be combined directly in one device.

The present invention provides a hydraulic and/or electrical controller comprising a variant of an above-described communication module. The hydraulic controller can comprise a programmable logic controller. The communication module can provide a user interface irrespective of the fieldbus used in the hydraulic and/or electrical controller. For example, it is also possible for a suitable controller to actuate electrical actuators via a bus.

The present invention provides a method for communicating with a fieldbus device, which method comprises the following steps:

reading at least one parameter from the at least one fieldbus device that can be connected and/or is connected to the fieldbus interface via a fieldbus;
creating a user interface using the at least one parameter; and
providing the user interface for a Human Machine Interface.

The method of communicating with a fieldbus device can also be used to implement efficiently and economically the idea behind the present invention.

In addition, in the step of reading, it is possible to transfer or transmit the at least one parameter via the fieldbus and, simultaneously or alternatively, via the fieldbus interface to a connectable and/or connected fieldbus device.

In one embodiment, a variant of the above-described communication module can be designed to perform or implement in corresponding devices the steps of a variant of a method presented here. Again, this embodiment variant of the invention in the form of a communication module can be used to achieve quickly and efficiently the object of the invention.

A computer program product containing program code is also advantageous, which program code can be stored on a machine-readable storage medium such as a semiconductor memory, a hard disk or an optical memory, and is used to implement the method according to any of the above-described embodiments when the program product is executed on a computer, a communication module or a device.

The invention is explained in greater detail below with reference to the accompanying drawings, in which:

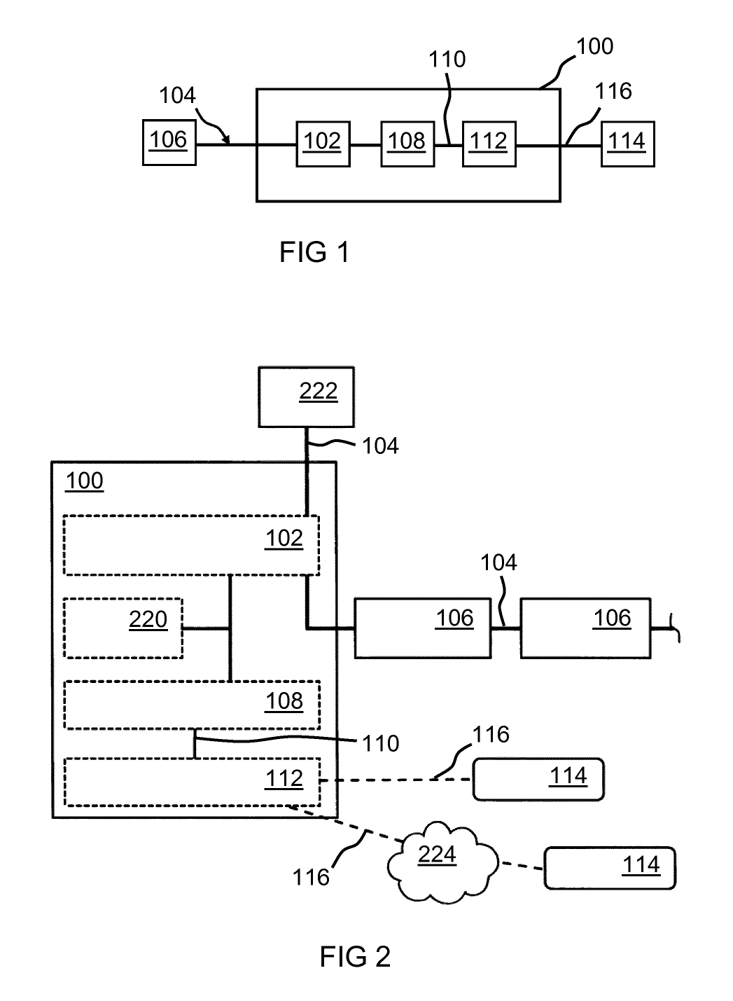

FIG. 1 is a schematic diagram of a communication module according to an exemplary embodiment of the present invention;

FIG. 2 is a block diagram of a communication module according to an exemplary embodiment of the present invention; and

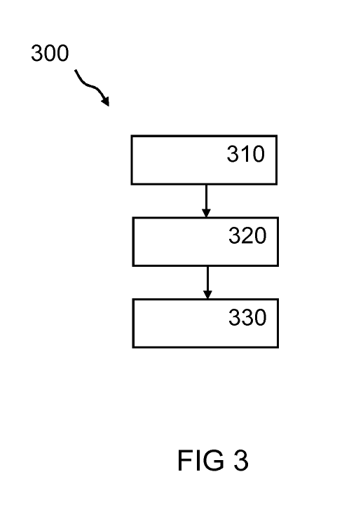

FIG. 3 is a flowchart of a method for communicating with a fieldbus device according to an exemplary embodiment of the present invention.

Identical or similar elements may be denoted by identical or similar reference signs in the figures below. In addition, the figures in the drawings, the description thereof and the claims contain combinations of numerous features. It is obvious to a person skilled in the art that these features can also be considered individually or can be grouped in other combinations that are not explicitly described here.

FIG. 1 shows a schematic diagram of a communication module 100 for at least one fieldbus device according to an exemplary embodiment of the present invention. The communication module 100 comprises a fieldbus interface 102, which is designed to retrieve at least one parameter from the at least one fieldbus device 106 that can be connected and/or is connected via a fieldbus 104 to the fieldbus interface 102, and/or to modify said at least one parameter, and comprises a data processing unit 108, which is designed to provide a user interface 110 for the at least one parameter, and a communication interface 112, which is designed to provide the user interface 110 for a Human Machine Interface 114.

In one exemplary embodiment, the communication interface 112 is designed to provide the user interface via a wireless or wired network 116. Depending on the particular exemplary embodiment, the network 116 is implemented for accesses confined to local use, for instance as LAN, wireless LAN (WLAN), Bluetooth, Zigbee, or for mobile accesses, for instance as UMTS, LTE or another mobile communications standard. In addition, in one exemplary embodiment, the network 116 is connected to the Internet, for instance in order to perform telemaintenance tasks globally.

Depending on the particular exemplary embodiment, the Human Machine Interface 114 is in the form of a computer, a portable computer such as a notebook for example, a smartphone or a tablet. In one exemplary embodiment, the Human Machine Interface 114 is a device comprising a communication interface, a display device such as a screen, and an input device such as a keyboard or a touchscreen on the display device.

The communication module 100 in one exemplary embodiment is embodied as a substantially cuboid housing having a connection for the fieldbus interface 102 and a connection for the communication interface 112 and comprises an integrated circuit, wherein the data processing unit 108 is part of the integrated circuit and wherein the fieldbus interface 102 is connected to the communication interface 112 via the integrated circuit.

In one exemplary embodiment, the housing has a maximum edge length of 18 centimeters. In one exemplary embodiment, the housing has a size of 18 cm×12 cm×5 cm. The minimum height of the housing is determined by the mechanical dimensions of the fieldbus interface 102 and of the communication interface 112. In one exemplary embodiment, the interfaces are arranged on a circuit board and connected to one another via an integrated circuit, wherein the integrated circuit comprises the data processing unit 108.

In one exemplary embodiment, the user interface 110 is a Web interface. In this case, the data processing unit 108 comprises a Web server, which can be accessed via the communication interface 112. A browser integrated in the Human Machine Interface 114 can be used to open and display the Web interface.

The data processing unit 108 is designed in one exemplary embodiment to use the at least one parameter to control at least one function of the at least one fieldbus device 114.

In one exemplary embodiment, the communication module 100 is designed to detect the at least one fieldbus device 106 that can be connected and/or is connected via the fieldbus interface 102 and/or via the fieldbus 104, and to provide information about the at least one parameter and/or the at least one function for a plurality of fieldbus devices 106 that can be connected via the fieldbus interface 102 and/or via the fieldbus 104.

Depending on the particular exemplary embodiment, the fieldbus interface 112 is embodied as a Profinet interface, a Sercos interface, a CAN interface, a CANopen interface, a Profibus interface, a Foundation Fieldbus interface, an EtherCAT interface, a VARAN bus interface or an INTERBUS interface. In one exemplary embodiment, the fieldbus interface 112 comprises at least two different interfaces of the listed interfaces in order to be able to communicate with fieldbus devices 106 that have different fieldbuses.

In one exemplary embodiment, the communication module 100 is part of a hydraulic and/or electrical controller, and is connected to said controller via a fieldbus 104.

FIG. 2 shows a block diagram of a communication module 100 according to an exemplary embodiment of the present invention. The communication module 100 may be an exemplary embodiment of the communication module 100 described in FIG. 1. The communication module 100 comprises a fieldbus interface 102, a data processing unit 108 and a communication interface 112. In addition in the exemplary embodiment, the communication module 100 comprises a storage device 220. The storage device 220 is designed to store the at least one parameter and/or a plurality of the at least one parameter, which is read via a fieldbus 104 connected to the fieldbus interface 102 and a fieldbus device 106 connected to the fieldbus 104.

In the exemplary embodiment shown in FIG. 2, two field devices 106 are shown on the fieldbus 104. In addition, the communication module 100 is connected via the fieldbus to a programmable logic controller 222 (PLC 222), or the communication module 100 can be connected to a PLC 222. The field devices 106 may be sensors and/or actuators, depending on the exemplary embodiment. It is also possible that another PLC is understood to be a field device 106.

In the exemplary embodiment shown, a terminal 114, or more precisely a Human Machine Interface 114, is connected directly via the network 116, and a terminal 114, or more precisely a Human Machine Interface 114, is connected to the communication interface 112 via the Internet 224. The Internet 224 is in this case connected in the network 116, or in other words the network is extended across the Internet 224.

One aspect of the presented invention is a fieldbus installation comprising a plurality of connected devices 106, for example drive controllers or the like, to which is connected a communication module 100. The module 100 has a fieldbus interface 102 and a submodule 108, which provides a user interface 110 (for instance in the form of a Web interface 110). This user interface 110 is externally accessible via a further interface 112. This is actually where the difference lies from a standard fieldbus gateway or converter, namely that the communication module 100 itself provides a user interface 110. Hence it is possible to open only the data that is enabled by the user interface 110, or to control only those functions of the fieldbus devices 106 that are implemented at the user interface 110. In addition, the communication module 100 comprises in one exemplary embodiment a routine for detecting fieldbus devices 106 and a database containing function data and communication data for the potentially connected devices 106.

The communication module 100 is connected to the fieldbus 104 (for example Sercos, Profinet, etc.). The interpreter 102 can retrieve and/or modify parameters from the fieldbus devices 106, and provide said parameters to the user interface 110 (for example Web interface 110) or to the data storage device 220 (for example a MySQL database). The communication module 100 allows access to the cross-platform user interface 110 both locally (for instance via LAN, wireless LAN, Bluetooth, Zigbee, etc.) and via the Internet 224 (for instance UMTS, 3G, etc.). The terminals 114 can in this case be any Human Machine Interfaces 114 (or HMI 114) (for instance PCs, laptops, smartphones, tablets, etc.).

The case above concerns a communication module 100 for fieldbus devices 106.

In one exemplary embodiment, the communication module 100 is designed as a discrete device which is connected to the fieldbus 104 and which, via said fieldbus, can read parameters from the connected field device 106 and can write same. In one exemplary embodiment, the communication module 100 allows simultaneous storage on the device 100 and, via the built-in communication facilities, allows local provision (e.g. a wireless network or Wi-Fi) and global provision (e.g. UMTS) for terminals 114 connected to the network 116. The data is advantageously displayed and input on cross-platform interface 110 (e.g. Web interface) in order to allow the user access without additional software on the largest possible range of terminals 114 (e.g. PC, smartphone, tablet, etc.).

The advantages of the exemplary embodiment presented are simpler commissioning (e.g. quick plausibility tests checking the correct connections of hydraulic lines), condition monitoring (e.g. recording temperature curves and identifying trends therein), and easier and faster troubleshooting (reading the parameters directly without additional software). In one exemplary embodiment, the communication module 100 facilitates telemaintenance and support from off-site service staff.

The communication module 100 may be used, for example, in a hydraulic and/or electrical controller.

FIG. 3 shows a flowchart of a method 300 for communicating with a fieldbus device according to an exemplary embodiment of the present invention. The method 300 can be implemented on a communication module 100 such as that described in FIG. 1 and FIG. 2. The method 300 comprises a step 310 of reading at least one parameter from the at least one fieldbus device, which can be connected and/or is connected via the fieldbus, a step 320 of creating a user interface using the at least one parameter, and a step 330 of providing the user interface for a Human Machine Interface.

The exemplary embodiments shown have been chosen merely by way of example and can be combined with one another.

### LIST OF REFERENCES

100 communication module
102 fieldbus interface
104 fieldbus
106 fieldbus device
108 data processing unit
110 user interface
112 communication interface
114 Human Machine Interface/terminal
116 network
220 storage device
222 programmable logic controller (PLC)
224 Internet
300 method
310 step of reading
320 step of creating
330 step of providing

1. A communication module for at least one fieldbus device, comprising:
at least one fieldbus interface configured to retrieve at least one parameter from the at least one fieldbus device that can be connected and/or is connected via a fieldbus to the fieldbus interface, and/or to modify the at least one parameter;
a data processing unit configured to provide a user interface for the at least one parameter; and
a communication interface configured to provide the user interface for a Human Machine Interface.

2. The communication module as claimed in claim 1, further comprising:
a substantially cuboid housing having a connection for the at least one fieldbus interface and a connection for the communication interface; and
an integrated circuit,
wherein the data processing unit is part of the integrated circuit, and
wherein the at least one fieldbus interface is connected to the communication interface via the integrated circuit.

3. The communication module as claimed in claim 1, further comprising:
a storage device configured to store the at least one parameter and/or a plurality of the at least one parameter.

4. The communication module as claimed in claim 1, wherein the user interface is a Web interface.

5. The communication module as claimed in claim 1, wherein the data processing unit is configured to use the at least one parameter to control at least one function of the at least one fieldbus device.

6. The communication module as claimed in claim 1, wherein the data processing unit is configured to detect the fieldbus device that can be connected and/or is connected via the fieldbus interface and/or via the fieldbus, and/or to provide information about the at least one parameter and/or the at least one function for a plurality of fieldbus devices that can be connected and/or are connected via the fieldbus interface and/or via the fieldbus.

7. The communication module as claimed in claim 1, wherein the at least one fieldbus interface includes a Profinet interface and/or a Sercos interface and/or a CAN interface and/or a CANopen interface and/or a Profibus interface and/or a Foundation Fieldbus interface and/or an EtherCAT interface and/or an INTERBUS interface and/or a VARAN bus interface.

8. The communication module as claimed in claim 1, wherein the Human Machine Interface includes a computer and/or a portable computer and/or a smartphone and/or a tablet.

9. The communication module as claimed in claim 1, wherein an hydraulic and/or a electrical controller comprises the communication module.

10. A method for communicating with a fieldbus device, comprising:
reading at least one parameter from the at least one fieldbus device that can be connected and/or is connected to at least one fieldbus interface via a fieldbus;
creating a user interface using the at least one parameter; and
providing the user interface for a Human Machine Interface.
